(19) United States
(12) Patent Application Publication
(10) Pub. No.: US 2003/0115058 A1
(43) Pub. Date: Jun. 19, 2003

(54) System and method for user-to-user communication via network

(76) Inventors: Chan Yong Park, Taejon (KR); Byung Tae Jang, Taejon (KR); Ju Wan Kim, Taejon (KR); Jeong Dan Choi, Taejon (KR)

Correspondence Address: JACOBSON, PRICE, HOLMAN & STERN, PROFESSIONAL LIMITED LIABILITY COMPANY, 400 Seventh Street. N.W., Washington, DC, 20004, US

(21) Appl. No.: 10/066,731

(22) Filed: Feb. 6, 2002

(30) Foreign Application Priority Data
Dec. 13, 2001 (KR) 2001-78765

(51) Int. Cl. G10L 15/26; G10L 15/00

(52) U.S. Cl. 704/235

(57) ABSTRACT

The present invention relates to a user-to-user communication system and method via a network. The communication system and method recognizes a first audio signal which is inputted from a user, converts the first audio signal into a first text data, and transmits the converted first text data, applied with a transmission code, into a counterpart terminal via the network; and receives a data applied with a transmission code from the counterpart terminal and converts the data into a second audio signal to output the same via a speaker. When one of users or garners wants to have a conversation with a counterpart gamer during a multi-user network game, communication among users participating in a multi-user on-line game can be smoothly executed in a narrow network bandwidth.

### BACKGROUND OF THE INVENTION

1. Field of the Invention

The present invention relates to a user-to-user communication system and method via a network, in particular, by which communication among users participating in a multi-user on-line game is smoothly executed in a narrow network bandwidth.

2. Description of the Related Art

Recently, development of the Internet uses computers by a rapidly growing amount, resulting in appearance of various fields and methods of off-line and on-line games.

As development of the computer games rapidly progresses like this, competition among game developers is also gradually growing severe. Therefore, the game developers each are concentrating on schemes for maximizing interests of gamers.

For example, the game developers diversify the computer games into Arcade Games, Simulation Games, Adventure games and the like to discriminate the kind of the games according to the inclination of the gamers. Also, the game developers are seriously considering those schemes to vary entire stories of the games by developing new scenarios for the games.

In the games as above, a game server supports one-to-one or one-to-multi connections off-line or on-line, i.e., via the Internet so that the games can be executed.

In order to allow a conversation or communication among the gamers participating in such a multi-user on-line game, the game has adopted methods in which a text data is transmitted/received using a keyboard after calling a counterpart or methods in which a compressed audio data is transmitted/received.

When communication is executed among the gamers with the text data using the keyboard, there is barely a sufficient time to input the text data using the key board during the game, resulting in difficulty in communication. Recently, an increasing number of gamers are gradually communicating with audio. However, since a network bandwidth for communication is narrow, the communication is mostly executed with text but barely with audio.

### SUMMARY OF THE INVENTION

Accordingly, the present invention has been devised to solve the foregoing problems and it is an object of the invention to provide a user-to-user communication system and method via a network, in particular, by which communication among users participating in a multi-user on-line game is smoothly executed with audio or text in a narrow network bandwidth.

In accordance with an aspect of the invention to obtain the foregoing object, it is provided a user-to-user communication system via a network comprising: transmission means for recognizing a first audio signal which is inputted from a user, converting the first audio signal into a first text data, and transmitting the converted first text data, applied with a transmission code, into a counterpart terminal via the network; and receiving means for receiving a data applied with a transmission code from the counterpart terminal and converting the data into a second audio signal to output the same via a speaker.

Preferably, the transmission means comprises: an audio recognition block for recognizing the first audio signal inputted from the user; a text converter block for converting the first audio signal recognized in the audio recognition block into the first text data; a data synthesizer block for synthesizing the converted first text data with a text transmission code; and a data transmission block for transmitting the first text data having the text transmission code synthesized thereto into the counterpart terminal via the network.

Preferably, the transmission means further comprises: an audio compressing block for compressing the first audio signal from the audio recognition block into an audio data if the first audio signal is incompletely recognized; and a data synthesizer block for synthesizing the audio data compressed in the audio compressing block with an audio transmission code and transmitting the synthesized audio data into the counterpart terminal via the data transmission block.

Also, it is preferred that the receiving means comprises: a data receiving block for receiving the data including the transmission code from the counterpart terminal; data separating means for judging the kind of the received data based upon the transmission code included therein to separate a second text data; and an audio signal converting block for converting the second text data, which is separated from the data separating means, into the second audio signal to output the same.

It is preferred that the receiving means further comprises: a decompressing block for decompressing a compressed audio signal to output the same via the speaker if the received data is judged as the compressed audio data in the data separating means. Alternatively, the network may be a wire or wireless network.

In accordance with another aspect of the invention to obtain the foregoing object, it is provided a user-to-user communication method via a network comprising the following steps of: recognizing a first audio signal inputted from a user; converting the recognized first audio signal into a first text data; synthesizing the converted first text data with a text transmission code; transmitting the first text data synthesized with the text transmission code into a counterpart terminal via the network and receiving a data including a transmission code from the counterpart terminal; judging the kind of the received data based upon the transmission code included therein to separate a second text data; and converting the separated second text data into a second audio signal to output the same via a speaker.

Preferably, the user-to-user communication method further comprises the steps of compressing the inputted first audio signal into a first audio data if the first audio signal is not recognized in the recognizing step; and transmitting the compressed first audio data into the counterpart terminal, synthesized with an audio transmission code.

Preferably, if the received data is judged as a compressed audio data in the judging and separating step, the user-to-user communication method further comprises the step of: decompressing the compressed audio data to output the same via the speaker. Alternatively, the network may be a wire or wireless network.

In accordance with a still another aspect of the invention to obtain the foregoing object, it is provided a digital processor-readable record medium including a realized program of command languages which can be executed by a digital processor for carrying out a user-to-user communication method via a network, wherein the program is executed in the following steps of: recognizing a first audio signal inputted from a user; converting the recognized first audio signal into a first text data; synthesizing the converted first text data with a text transmission code; transmitting the first text data synthesized with the text transmission code into a counterpart terminal via the network, and receiving a data including a transmission code from the counterpart terminal and judging the kind of the received data based upon the transmission code included therein to separate a second text data; and converting the separated second text data into a second audio signal to output the same via a speaker.

### BRIEF DESCRIPTION OF THE DRAWINGS

In the following drawings:

FIG. 1 schematically shows a structure of connection in a user-to-user communication system via a network in accordance with the invention;

FIG. 2 is a detailed block diagram of the user-to-user communication system via a network in FIG. 1;

FIG. 3 shows an operational flow chart for transmitting data in a user-to-user communication method via a network in accordance with the invention; and

FIG. 4 shows an operational flow chart for receiving data in a user-to-user communication method via a network in accordance with the invention.

### DETAILED DESCRIPTION OF THE PREFERRED EMBODIMENT

The following detailed description will present a user-to-user communication system and method via network in accordance with preferred embodiments of the invention in reference to the accompanying drawings.

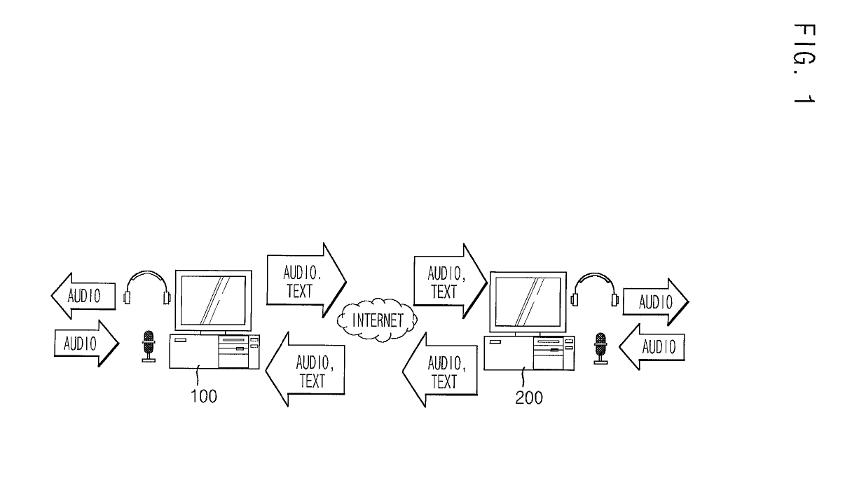

FIG. 1 schematically shows a structure of connection in a user-to-user communication system via a network in accordance with the invention.

As shown in FIG. 1, a user terminal 100 of the first user is connected to a user terminal 200 of the second user via the Internet. Each of the first and second user terminals 100 and 200 can be provided with a microphone for inputting an audio signal and a speaker for outputting the audio signal.

During an on-line game proceeding between the two mutually connected user terminals, when the first user wants to have a conversation with the second user using the user terminal 100 via the Internet, the first user inputs an audio signal via a microphone mounted to the user terminal 100; and the first user terminal 100 recognizes the inputted audio signal of the first user, converts the recognized audio signal into a text data, and then transmits the text data into the second user terminal 200 via the Internet.

The second user terminal 200 receives the text data transmitted from the first user terminal 100 via the Internet, converts the received text data into an audio signal, and then outputs the audio signal via a speaker.

Data transmission between the user terminals is executed by converting the audio data into the text data rather than transmitting the audio data. Therefore, data transmission/receiving can be executed in an Internet bandwidth narrower than those required for common audio data transmission.

Alternatively, when the audio signal inputted from the first user cannot be recognized, the inputted audio signal is compressed and then transmitted to the second user terminal 200 via the Internet. The second user terminal 200 decompresses the received audio data, and then outputs the decompressed audio data via the speaker.

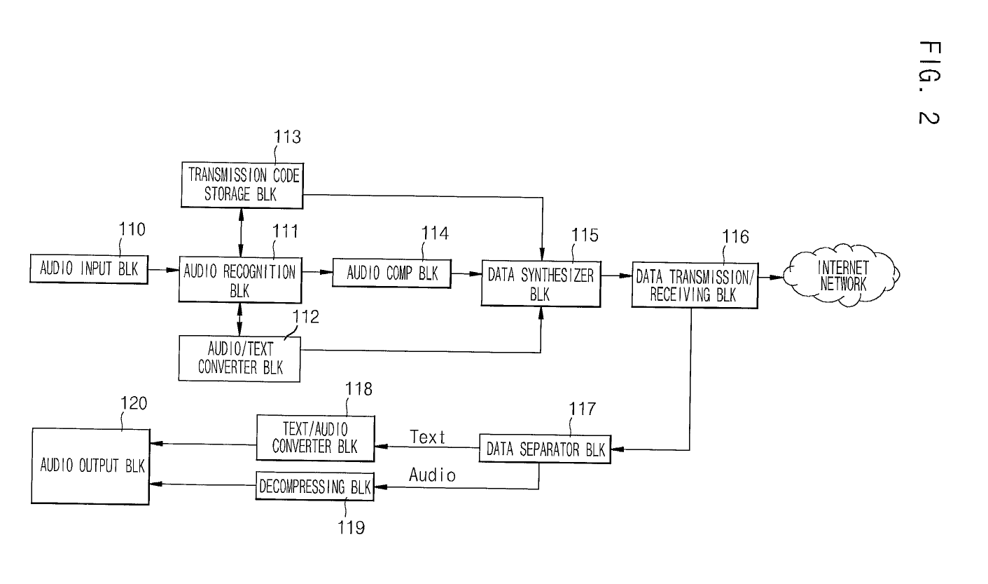

Such a transmission/receiving operation of data will be described in more detail in reference to FIG. 2.

FIG. 2 is a detailed block diagram of the user-to-user communication system via a network in FIG. 1.

As shown in FIG. 2, in the user-to-user communication system via a network, each of the user terminals 100 and 200 is comprised of a data transmission unit and a data-receiving unit. The data transmission unit includes an audio input block 110 for inputting an audio signal of a user; an audio recognition block 111 for recognizing the audio signal of the user inputted via the audio input block 110; an audio/text converter block 112 for converting the audio signal recognized in the audio recognition block 111 into a text data; and an audio compressing block 114 for compressing the corresponding audio signal if the inputted audio signal is not completely recognized. Herein; the audio input block 110 can be constituted by a microphone.

The data transmission unit further includes a transmission code storage block 113 storing transmission codes for discriminating the audio data from the text data; a data synthesizer block 115 for synthesizing the audio data compressed in the audio compressing block 114 with an audio transmission code or synthesizing the text data converted in the audio/text converter block 112 with a text transmission code stored in the transmission code storage block 113; and a data transmission block 116 for transmitting a data synthesized in the data synthesizer block 115 into an terminal of another gamer or user, which is on-line connected, via the Internet.

The data receiving unit includes a data receiving block 116 for receiving the data transmitted from the terminal of the corresponding gamer or user via the Internet; a data separator block 117 for analyzing the kind of the received data using the transmission code included in the data and then separating the corresponding data; a text/audio converter block 118 for converting the data separated in the data separator block 117 into an audio signal if the data is a text data; a decompressing block 119 for decompressing the data separated in the data separator block 117 if the data is a compressed audio data; and an audio output block 120 for outputting the audio signal decompressed in the decompressing block 119 or the audio data converted in the text/audio converter block 118 so as to be heard by the gamer. Herein, the audio output block 120 may be constituted by a speaker.

Hereinafter it will be described about the operational principle of the user-to-user communication system via a network having the configuration set forth above in accordance with the invention.

When one of the users or gamers wants to have a conversation with the counterpart during an on-line game proceeding among the users via the Internet, the user inputs an audio signal, which he/she wants to talk to the counterpart, via the audio input block 110.

The audio signal inputted via the audio input block 110 is recognized in the audio recognition block 111, which provides the audio signal to the audio/text converter block 112 if the entire inputted audio signal is recognized.

However, when the inputted audio signal is not completely recognized or an error takes place during recognition, the corresponding audio signal is sent to the audio compressing block 114.

When the inputted audio signal is successfully recognized, the audio/text converter block 112 converts the audio data from the audio recognition block 111 into the text data, which is sent to the data synthesizer block 115.

The data synthesizer block 115 outputs the text data converted in the audio/text converter block 112, synthesized with the text transmission code stored in the transmission code storage block 113, into the data transmission/receiving block 116, in which the text transmission code is inserted at the head of the text data or a character string.

The data transmission/receiving block 116 transmits the text data, which has the text transmission code inserted thereto, from the data synthesizer block 115 into the terminal of the counterpart, which the first user wants to have a conversation with, via the Internet. The transmission into the counterpart terminal is executed via a server. The configuration of the server is not shown in the drawings.

When the inputted audio signal is not recognized in the audio recognition block 111 or an error takes place during recognition, the inputted audio signal is sent to the audio compressing block 114.

The audio data compressed like this is sent to the data synthesizer block 115. The data synthesizer block 115 inserts the audio transmission code, which is stored in the transmission code storage block 113, into the compressed audio data, and then sends the compressed audio data into the transmission/receiving block 116. Therefore, the data transmission/receiving block 116 transmits the compressed audio data with the audio transmission code into the counterpart terminal, which the first user wants to have a conversation with, via the Internet.

In sequence, hereinafter description will be made about the receiving operation when the first user terminal transmitted the text data or audio data in accordance with the method set forth above.

When any data is received in the data transmission/receiving block 116 via the Internet, the data separator block 117 analyzes the transmission code included in the received data to judge whether the corresponding data is an audio data or a text data, and then separates the data.

If the data separated in the data separator block 117 is a text data, the corresponding text data is converted into an audio signal in the text/audio converter block 118, and then the audio signal is outputted via the audio output block 120.

If the data separated in the data separator block 117 is a compressed audio data, the compressed audio data is decompressed in the decompressing block 119, and a decompressed audio signal is outputted via the audio output block 120. In accordance with the data transmission/receiving method as set forth above, communication is carried out during a game proceeding among the gamers.

Hereinafter description will be made step-by-step about a user-to-user communication method via a network in accordance with the invention corresponding to the user-to-user communication system via a network in accordance with the invention in reference to the accompanying drawings. The communication method will be divided into a data transmission method and a data receiving method in description thereof.

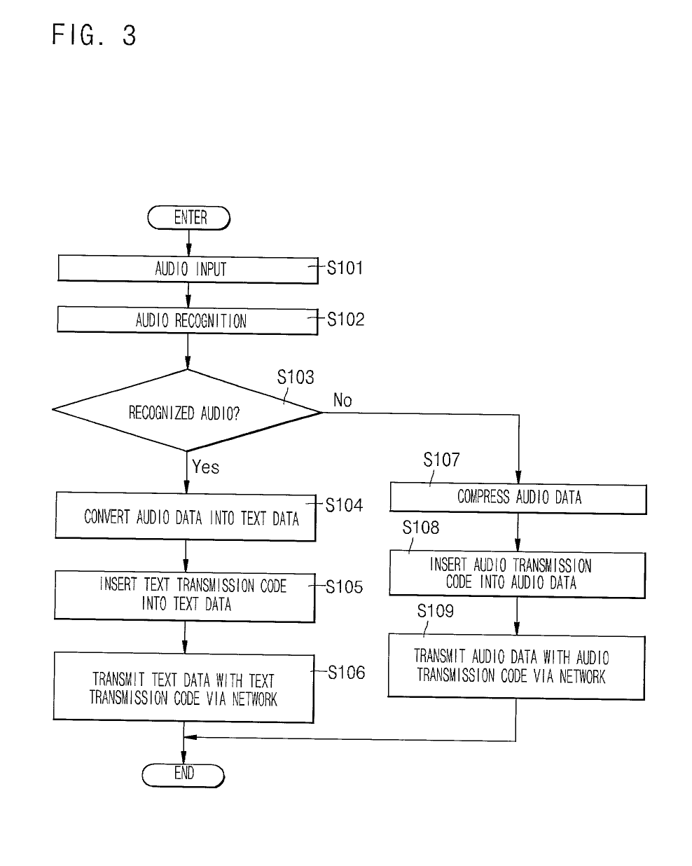

FIG. 3 shows an operational flow chart for transmitting data in a user-to-user communication method via a network in accordance with the invention.

First, during an on-line game proceeding among users via the Internet, when one of the users or gamers inputs an audio signal in order to have a conversation with a counterpart in S101, the inputted audio signal is recognized in S102.

It is judged whether the inputted audio signal is completely recognized in S103, and if the inputted audio signal is completely recognized, the corresponding audio data is converted into a text data in S104.

The converted text data is synthesized with a pre-stored text transmission code in S105, and then the text data having the synthesized transmission code is transmitted into the counterpart terminal via the network in S106.

If the inputted audio signal is not completely recognized or an error takes place in S103, the inputted audio data is compressed in S107.

After a pre-stored audio transmission code is inserted into the compressed audio data in S108, the compressed audio data with the audio transmission code is transmitted into the counterpart terminal, which the first user wants to have a conversation with, via the Internet in S109.

The foregoing process is summarized as follows: When the first gamer speaks during the game, the audio signal from the first gamer is recognized. If the audio recognition is complete, the audio signal is converted into the text without transmitting the audio signal. The text transmission code is inserted into the converted text data, and then the text transmission code is transmitted followed by transmission of the converted text data. If the audio recognition is not complete or a monosyllable word such as interjection which can be hardly recognized is inputted, the corresponding audio signal is compressed, and then the audio transmission code is inserted into the compressed audio signal. The inserted audio signal is first transmitted, followed by the compressed audio data.

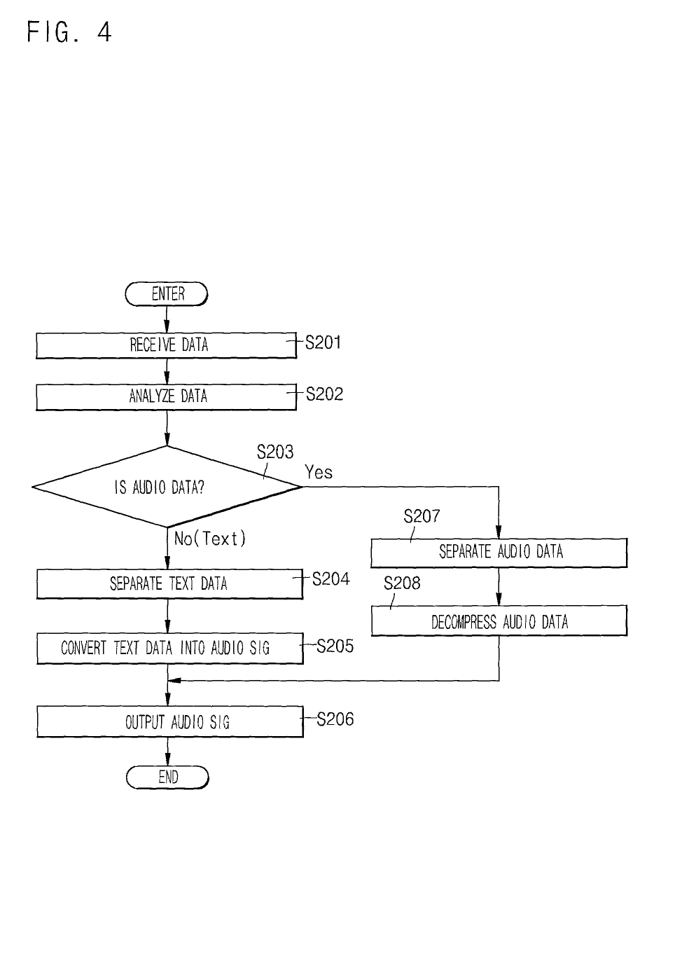

FIG. 4 shows an operational flow chart for receiving data in a user-to-user communication method via a network in accordance with the invention.

If any data is transmitted from the counterpart terminal via the Internet as shown in FIG. 3, the terminal of the second user or gamer receives the corresponding data in S201.

The received data is analyzed in S202, and then the transmission code included in the received data is analyzed to judge whether the received data is the compressed audio data in S203.

If the received data is judged as the text data instead of the compressed audio data, the corresponding text data is separated in S204, the separated text data is converted into the audio data in S205, and the converted audio data is outputted via the speaker S206.

However, if the received data is judged as the compressed audio data in S203, the corresponding compressed data is separated in S207, and then the separated compressed audio data is decompressed in S208. The decompressed audio signal is outputted via the speaker in S206.

In short, the transmission code included in the data, which is received via the network or Internet, is analyzed to judge whether the corresponding data is the audio or text data. If the corresponding data is the compressed audio data, the corresponding data is decompressed, and then the decompressed audio signal is outputted via the speaker. If the received data is the text data, the text data is converted into the audio signal, which is outputted via the speaker.

In the user-to-user communication system and method via a network in accordance with the invention as set forth above, when one of the gamers speaks during the game, the audio signal of the first gamer is recognized. If audio recognition is complete, the audio signal is converted into the text data without transmission of the audio signal, and the text transmission code is inserted into the converted text data. The text transmission code is first transmitted, followed by the converted text data. If audio recognition is not complete or a monosyllable word such as interjection which is hardly recognized is inputted, the corresponding audio signal is compressed and the audio transmission code is inserted into the compressed audio signal. The inserted audio transmission code is first transmitted, followed by the compressed audio data.

The transmission code included in the data, which is received via the network or Internet, is analyzed to judge whether the corresponding data is the audio data or the text data. If the received data is the audio data, the corresponding audio data is decompressed into the audio signal, which is outputted via the speaker. If the received data is the text data, the corresponding text data is converted into the audio signal, which is outputted via the speaker.

Accordingly, when one of the gamers wants to have a conversation with the counterpart gamer during execution of the multi-user network game, the inputted audio signal is transmitted into the counterpart terminal, converted into the text data, and the counterpart terminal outputs the received text data after converting into the audio data. Therefore, there is an advantage that communication can be smoothly executed among the gamers even in the narrow network bandwidth.

What is claimed is:

1. A user-to-user communication system via a network comprising:
transmission means for recognizing a first audio signal which is inputted from a user, converting the first audio signal into a first text data, and transmitting the converted first text data, applied with a transmission code, into a counterpart terminal via the network; and
receiving means for receiving a data applied with a transmission code from the counterpart terminal and converting the data into a second audio signal to output the same via a speaker.

2. A user-to-user communication system via a network in accordance with claim 1, wherein the transmission means comprises:
an audio recognition block for recognizing the first audio signal inputted from the user;
a text converter block for converting the first audio signal recognized in the audio recognition block into the first text data;
a data synthesizer block for synthesizing the converted first text data with a text transmission code; and
a data transmission block for transmitting the first text data having the text transmission code synthesized thereto into the counterpart terminal via the network.

3. A user-to-user communication system via a network in accordance with claim 2, wherein the transmission means further comprises:
an audio compressing block for compressing the first audio signal from the audio recognition block into an audio data if the first audio signal is incompletely recognized; and
a data synthesizer block for synthesizing the audio data compressed in the audio compressing block with an audio transmission code and transmitting the synthesized audio data into the counterpart terminal via the data transmission block.

4. A user-to-user communication system via a network in accordance with claim 1, wherein the receiving means comprises:
a data-receiving block for receiving the data including the transmission code from the counterpart terminal;
data separating means for judging the kind of the received data based upon the transmission code included therein to separate a second text data; and
an audio signal converting block for converting the second text data, which is separated from the data separating means, into the second audio signal to output the same.

5. A user-to-user communication system via a network in accordance with claim 4, wherein the receiving means further comprises:
a decompressing block for decompressing a compressed audio signal to output the same via the speaker if the received data is judged as the compressed audio data in the data separating means.

6. A user-to-user communication system via a network in accordance with claim 1, wherein the network is a wire or wireless network.

7. A user-to-user communication method via a network, the method comprising the following steps of:
(a) recognizing a first audio signal inputted from a user;
(b) converting the recognized first audio signal into a first text data;
(c) synthesizing the converted first text data with a text transmission code;
(d) transmitting the first text data synthesized with the text transmission code into a counterpart terminal via the network and receiving a data including a transmission code from the counterpart terminal;
(e) judging the kind of the received data based upon the transmission code included therein to separate a second text data; and
(f) converting the separated second text data into a second audio signal to output the same via a speaker.

8. A user-to-user communication method via a network in accordance with claim 7, further comprising the steps of:
(g) compressing the inputted first audio signal into a first audio data if the first audio signal is not recognized in the recognizing step (a); and
(h) transmitting the compressed first audio data into the counterpart terminal, synthesized with an audio transmission code.

9. A user-to-user communication method via a network in accordance with claim 7, if the received data is judged as a compressed audio data in the judging and separating step (e), further comprising the step of. (i) decompressing the compressed audio data to output the same via the speaker.

10. A user-to-user communication method via a network in accordance with claim 7, wherein the network is a wire or wireless network.

11. A digital processor-readable record medium including a realized program of command languages which can be executed by a digital processor for carrying out a user-to-user communication method via a network, the program is executed in the following steps of:
recognizing a first audio signal inputted from a user;
converting the recognized first audio signal into a first text data;
synthesizing the converted first text data with a text transmission code;
transmitting the first text data synthesized with the text transmission code into a counterpart terminal via the network, and receiving a data including a transmission code from the counterpart terminal and judging the kind of the received data based upon the transmission code included therein to separate a second text data; and
converting the separated second text data into a second audio signal to output the same via a speaker.
